(19) United States
(12) Patent Application Publication
(10) Pub. No.: US 2025/0062903 A1
(43) Pub. Date: Feb. 20, 2025

(54) MITIGATION AGAINST ACCESS TOKEN THEFT ATTACK IN DIRECT AND INDIRECT COMMUNICATIONS IN SBA

(71) Applicant: Nokia Technologies Oy, Espoo (FI)

(72) Inventors: Saurabh KHARE, Bangalore (BG); German PEINADO GOMEZ, Wroclaw (PL); Chaitanya AGGARWAL, Munich (DE)

(21) Appl. No.: 18/802,902

(22) Filed: Aug. 13, 2024

(30) Foreign Application Priority Data
Aug. 14, 2023 (IN) 202311054583

(51) Int. Cl. H04L 9/32; H04L 9/30

(52) U.S. Cl. CPC H04L 9/3213; H04L 9/30; H04L 9/3268

(57) ABSTRACT

Various examples of embodiments described herein relate to methods and apparatuses for mitigation against access token theft attack in direct and indirect communications in SBA. One such example of an embodiment relates to a method that includes obtaining a first access token request from a network function service consumer, NFc, the first access token request comprising an authentication code of the NFc; authenticate the network function consumer, NFc, based on a check whether the authentication code is signed by the NFc; sending a second access token request to a network authorization entity or function, wherein the second access token request comprises the authentication code of the NFc and the second access token request further comprises a public key of the NFc or a hash of the public key of the NFc; based thereon, receiving an access token from the network authorization entity or function, wherein the access token comprises the public key of the NFc or a hash of the public key of the NFc; and sending a service request to a network function service provider, NFp, wherein the service request comprises the access token and the authentication code of the NFc.

### TECHNICAL FIELD

Various examples of embodiments described herein relate to a method and an apparatus for mitigation against access token theft attack in direct and indirect communications in a service based architecture.

### BACKGROUND

Over time, an increasing extension of communication networks has taken place all over the world. Various organizations, such as the European Telecommunications Standards Institute (ETSI), the 3^{rd} Generation Partnership Project (3GPP), Telecoms & Internet converged Services & Protocols for Advanced Networks (TISPAN), the International Telecommunication Union (ITU), 3^{rd} Generation Partnership Project 2 (3GPP2), Internet Engineering Task Force (IETF), the IEEE (Institute of Electrical and Electronics Engineers), the WiMAX Forum and the like are working on standards or specifications for telecommunication networks and access environments.

Among one of those developments, service based architectures are being developed, and within this document, examples of embodiments described relate to such service based architectures, e.g. a Service-Based Architecture SBA as e.g. discussed in 3GPP for e.g. 5th generation, 5G, networks. Notwithstanding this, examples of embodiments described herein may be applicable to other scenarios different from 5G SBA, e.g. to scenarios developed within other standardization bodies or those of future network generations such as 5.25G, or 6G, or the like

By way of example, within such network architecture and/or service based architecture, SBA, 3GPP defines 5G Core Network Function's (NF's) interfaces and relevant Application Programming Interfaces (APIs) for each NF to communicate between NFs.

### SUMMARY

Various examples of embodiments described in the subject disclosure provide certain advantages, for example in the form of one or more improvements that are either explicitly described herein or otherwise apparent to a person skilled in the art from the subject disclosure. Hence, at least some examples of embodiments of the subject disclosure aim to provide (or otherwise contribute to) at least part of the aforementioned advantages and improvements.

Various aspects of examples of embodiments of the subject disclosure are set forth in the claims and pertain to methods, apparatuses and computer program products in the context of mitigation against access token theft attack in direct and indirect communications in SBA.

At least some of aforementioned advantages and improvements may be achieved through the methods, apparatuses and non-transitory storage media as specified in the claims. Further advantages and improvements may be achieved through the methods, apparatuses and non-transitory storage media set forth in respective dependent claims.

Insofar, according to various examples of embodiments, an apparatus may comprise: at least one processor; and at least one memory storing instructions that, when executed by the at least one processor, may cause the apparatus at least to: obtain a first access token request from a network function service consumer, NFc, the first access token request comprising an authentication code of the NFc; authenticate the network function service consumer, NFc, based on a check whether the authentication code is signed by the NFc; send a second access token request to a network authorization entity or function, wherein the second access token request comprises the authentication code of the NFc and the second access token request further comprises a public key of the NFc or a hash of the public key of the NFc; based thereon, receive an access token from the network authorization entity or function, wherein the access token comprises the public key of the NFc or a hash of the public key of the NFc; and send a service request to a network function service provider, NFp, wherein the service request comprises the access token and the authentication code of the NFc.

According to various examples of embodiments, the apparatus may further be caused to receive a service request comprising the authentication code from the NFc and obtain the first access token request by generating the first access token request based on the received service request; or obtain the first access token request by receiving the first access token request from the NFc.

According to various examples of embodiments, the apparatus caused to authenticate may further comprise the apparatus being caused to compare a public key included in the authentication code with a public key present in a Transport Layer Security (TLS) connection between the apparatus and the NFc; and/or compare a NF Instance ID included in the authentication code with a NF Instance ID present in a TLS certificate information associated with the TLS connection; and/or wherein the authentication code is signed based on the TLS certificate or via an OAuth signing private key of the NFc.

According to various examples of embodiments, the apparatus caused to send the second access token request may further comprise the apparatus being caused to add a signed authentication code of the apparatus to the second access token request; and/or sending the second access token request to the network authorization entity or function via at least one service communication proxy, SCP.

According to at least some examples of embodiments, an apparatus may comprise at least one processor; and at least one memory storing instructions that, when executed by the at least one processor, may cause the apparatus at least to: receive an access token request comprising an authentication code of a network function service consumer, NFc, and further comprising a public key of the NFc or a hash of the public key of the NFc; authenticate the NFc based on the authentication code of the NFc; verify, whether a public key included in the authentication code corresponds to the public key of the NFc; if verified that the public keys are the same, generate an access token comprising the public key of the NFc or a hash of the public key of the NFc; and send the access token to the NFc and/or a service communication proxy, SCP.

According to at least some examples of embodiments, the apparatus caused to verify may comprise the apparatus being caused to compare the public key included in the authentication code with a public key registered at a network authorization entity or function in relation to the NFc.

According to at least some examples of embodiments, wherein the received access request may further comprise an authentication code from a service communication proxy, SCP; and the apparatus caused to verify may further comprise the apparatus being caused to verify the authentication code from the SCP.

According to at least some examples of embodiments, the apparatus caused to generate said access token uses the public key of the NFc or a hash of the public key of the NFc stored in the NRF or received in the access token request.

According to at least some examples of embodiments, an apparatus may comprise: at least one processor; and at least one memory storing instructions that, when executed by the at least one processor, may cause the apparatus at least to: receive, from a service communication proxy, SCP, or from a network function service consumer, NFc, a service request comprising an access token and an authentication code of the NFc, the access token further comprising a public key of the NFc or a hash of the public key of the NFc; verify, whether the public key included in the access token is same as a public key included in the authentication code of the NFc; and if verified that the public keys are the same, send a service response to the NFc.

Further, according to various examples of embodiments, an apparatus may comprise means for obtaining a first access token request from a network function service consumer, NFc, the first access token request comprising an authentication code of the NFc; means for authenticating whether the authentication code is signed by the NFc; means for sending a second access token request to a network authorization entity or function, wherein the second access token request comprises the authentication code of the NFc and the second access token request further comprises a public key of the NFc or a hash of the public key of the NFc; based thereon, means for receiving an access token from the network authorization entity or function, wherein the access token comprises the public key of the NFc or a hash of the public key of the NFc; and means for sending a service request to a network function service provider, NFp, wherein the service request comprises the access token and the authentication code of the NFc.

According to various examples of embodiments, the apparatus may further comprise means for receiving a service request comprising the authentication code from the NFc and for obtaining the first access token request by generating the first access token request based on the received service request; or means for obtaining the first access token request by receiving the first access token request from the NFc.

According to various examples of embodiments, the apparatus may further comprise means for authenticating, which comprise means for comparing a public key included in the authentication code with a public key present in a TLS connection between the apparatus and the NFc; and/or means for comparing a NF Instance ID included in the authentication code with a NF Instance ID present in a TLS certificate information associated with the TLS connection; and/or wherein the authentication code is signed based on the TLS certificate or via an OAuth signing private key of the NFc.

According to various examples of embodiments, the apparatus may further comprise means for adding a signed authentication code of the apparatus to the second access token request; and/or means for sending the second access token request to the network authorization entity or function via at least one service communication proxy, SCP.

According to at least some examples of embodiments, an apparatus may comprise means for receiving an access token request comprising an authentication code of a network function service consumer, NFc, and further comprising a public key of the NFc or a hash of the public key of the NFc; means for authenticating the NFc based on the authentication code of the NFc; means for verifying, whether a public key included in the authentication code corresponds to the public key of the NFc; if verified that the public keys are the same, means for generating an access token comprising the public key of the NFc or a hash of the public key of the NFC; and means for sending the access token to the NFc and/or a service communication proxy, SCP.

According to at least some examples of embodiments, the apparatus may further comprise means for comparing the public key included in the authentication code with a public key registered at a network authorization entity or function in relation to the NFc.

According to at least some examples of embodiments, the received access request may further comprise an authentication code from a service communication proxy, SCP; and the apparatus may further comprise means for verifying the authentication code from the SCP.

According to at least some examples of embodiments, the apparatus may comprise means for generating said access token uses the public key of the NFc or a hash of the public key of the NFc stored in the NRF or received in the access token request.

According to at least some examples of embodiments, an apparatus may comprise means for receiving, from a service communication proxy, SCP, or from a network function service consumer, NFc, a service request comprising an access token and an authentication code of the NFc, the access token further comprising a public key of the NFc or a hash of the public key of the NFc; means for verifying, whether the public key included in the access token is same as a public key included in the authentication code of the NFc; and if verified that the public keys are the same, means for sending a service response to the NFc.

It should be understood that any of aforementioned apparatuses comprising “means for performing a processing” may equally be understood to correspond to an apparatus comprising “means configured to perform such process”.

According to at least some examples of embodiments, a method comprises obtaining a first access token request from a network function service consumer, NFc, the first access token request comprising an authentication code of the NFc; authenticating whether the authentication code is signed by the NFc; sending a second access token request to a network authorization entity or function, wherein the second access token request comprises the authentication code of the NFc and the second access token request further comprises a public key of the NFc or a hash of the public key of the NFc; based thereon, receiving an access token from the network authorization entity or function, wherein the access token comprises the public key of the NFc or a hash of the public key of the NFc; and sending a service request to a network function service provider, NFp, wherein the service request comprises the access token and the authentication code of the NFc.

Further, according to at least some examples of embodiments, the method may further comprise receiving a service request comprising the authentication code from the NFc and obtaining the first access token request by generating the first access token request based on the received service request; or obtaining the first access token request by receiving the first access token request from the NFc.

Furthermore, according to at least some examples of embodiments, the method may comprise that the authenticating comprises comparing a public key included in the authentication code with a public key present in a TLS connection between a service communication proxy, SCP, and the NFc; and/or comparing a NF Instance ID included in the authentication code with a NF Instance ID present in a TLS certificate information associated with the TLS connection; and/or wherein the authentication code is signed based on the TLS certificate or via an OAuth signing private key of the NFc.

Furthermore, according to at least some examples of embodiments, the method may comprise that the sending of the second access token request comprises adding a signed authentication code of the SCP to the second access token request; and/or sending the second access token request to the network authorization entity or function via at least one further SCP.

According to at least some examples of embodiments, a method comprises receiving an access token request comprising an authentication code of a network function service consumer, NFc, and further comprising a public key of the NFc or a hash of the public key of the NFc; authenticating the NFc based on the authentication code of the NFc; verifying, whether a public key included in the authentication code corresponds to the public key of the NFc; if verified that the public keys are the same, generating an access token comprising the public key of the NFc or a hash of the public key of the NFc; and sending the access token to the NFc and/or a service communication proxy, SCP.

Further, according to at least some examples of embodiments, the method may comprise that the verifying comprises comparing the public key included in the authentication code with a public key registered at a network authorization entity or function in relation to the NFc.

Further, according to at least some examples of embodiments, the the received access request may further comprise a authentication code from a service communication proxy, SCP; and the verifying may further comprise verifying the authentication code from the SCP.

Further, according to at least some examples of embodiments, the generating said access token comprises using the public key of the NFc or a hash of the public key of the NFc stored in the NRF or received in the access token request.

According to at least some examples of embodiments, a method comprises receiving, from a service communication proxy, SCP, or from a network function service consumer, NFc, a service request comprising an access token and an authentication code of the NFc, the access token further comprising a public key of the NFc or a hash of the public key of the NFc; verifying, whether the public key included in the access token is same as a public key included in the authentication code of the NFc; and if verified that the public keys are the same, sending a service response to the NFc.

According to at least some examples of embodiments, the authentication code may be a client credentials assertion, CCA.

Furthermore, according to various examples of embodiments, there may be provided a computer program product for a computer, including software code portions for performing the steps of any of the above-outlined methods, when said product is run on the computer.

According to at least some examples of embodiments, the computer program product may include a computer-readable medium on which said software code portions are stored, and/or the computer program product may be directly loadable into the internal memory of the computer and/or transmittable via a network by means of at least one of upload, download and push procedures.

Any one of the aspects mentioned according to the claims facilitates mitigation against access token theft attack in direct and indirect communications in SBA, thereby providing at least part of the aforementioned advantages and improvements.

In more detail, the subject disclosure describes mitigation against access token theft attack in direct and indirect communications in SBA, which may, according to some examples of embodiments, prove advantageous over a proprietary solution for at least the following reasons.

Further advantages may become apparent to a person skilled in the art from the following detailed description.

### BRIEF DESCRIPTION OF THE DRAWINGS

Some examples of embodiments of the subject disclosure are described below, by way of example only, with reference to the accompanying drawings, in which:

FIG. 1 (including part 1 of 2 and part 2 of 2) shows signaling flows in relation to mitigation against access token theft attack in direct and indirect communications in SBA according to various examples of embodiments of the subject disclosure;

FIG. 2 (including part 1 of 2 and part 2 of 2) shows signaling flows in relation to mitigation against access token theft attack in direct and indirect communications in SBA according to various examples of embodiments of the subject disclosure;

FIG. 3 shows a flowchart illustrating steps corresponding to an example method according to various examples of embodiments of the subject disclosure;

FIG. 4 shows a flowchart illustrating steps corresponding to an example method according to various examples of embodiments of the subject disclosure;

FIG. 5 shows a flowchart illustrating steps corresponding to an example method according to various examples of embodiments of the subject disclosure;

FIG. 6 shows a block diagram illustrating an example apparatus according to various examples of embodiments of the subject disclosure;

FIG. 7 shows a block diagram illustrating an example apparatus according to various examples of embodiments of the subject disclosure; and

FIG. 8 shows a block diagram illustrating an example apparatus according to various examples of embodiments of the subject disclosure.

### DETAILED DESCRIPTION

In general, two or more end points involved in a communication therebetween may be implemented as a particular type of end point (e.g. a communication station or entity or function, such as a terminal device, user equipment (UE), or other communication network element, a database, a server, host, etc.), or as one or more network elements or functions (e.g. virtualized network functions), such as communication network control elements or functions, for example access network elements like access points (APs), radio base stations (BSs), relay stations, eNBs, gNBs etc., and core network elements or functions, for example control nodes, support nodes, service nodes, gateways, user plane functions, access and mobility functions, etc. These end points may belong to a single communication network system, different communication network systems, or a combination of at least one same communication network system and at least one different communication network system.

In the following, various examples of embodiments will be described using, as an example of a communication network to which examples of embodiments may be applied, a communication network architecture based on 3GPP standards for a communication network, such as a 5G/NR, without restricting the examples of embodiments to such an architecture. It, however, is obvious for a person skilled in the art that the examples of embodiments may also be applied to other kinds of communication networks like 4G and/or LTE (and even 6G and higher) where mobile communication principles are integrated, e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but the subject disclosure can be extended and applied to any other type of communication network, such as a wired communication network or datacenter networking.

The following examples of embodiments are to be understood only as illustrative in nature. Although portions of the subject disclosure may refer to the expressions “an”, “one”, or “some” example(s) of embodiment(s) in several specific locations, this does not necessarily mean that each such reference is related to the same example(s) of embodiment(s), or that the described feature only applies to a single example of an embodiment. Individual features from different examples of embodiments may also be combined to provide other examples of embodiments. Furthermore, terms like “comprising” and “including” should be understood as not limiting the described examples of embodiments to consist of only those features that have been mentioned; such examples of embodiments can also contain features, structures, units, modules etc. that have not been specifically mentioned.

A simplified system architecture of a (tele) communication network including a mobile communication system, where some examples of embodiments, are applicable may include an architecture of one or more communication networks. The one or more communication networks may include wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an evolved NodeB (eNB) or a next generation NOdeB (gNB), a distributed or a centralized unit (CU), which controls a respective coverage area or cell(s) and with which one or more communication stations such as communication elements or functions, like user devices (e.g. customer devices), mobile devices, or terminal devices, like a UE, or another device having a similar function, such as a modem chipset, a chip, a module etc., which can also be part of a station, an element, a function or an application configured to conduct a communication, such as a UE, an entity or function usable in a machine-to-machine communication architecture, or attached as a separate element to such an element, function or application capable of conducting a communication, or the like, are configured to communicate via one or more channels via one or more communication beams for transmitting several types of data in a plurality of access domains. Furthermore, (core) network elements or network functions ((core) network control elements or network functions, (core) network management elements or network functions), such as gateway network elements/functions, mobility management entities, a mobile switching center, servers, databases and the like may be included.

Functions and interconnections of the described elements and functions, which also depend on the actual network type, are apparent to those skilled in the art and may be described in corresponding specifications, so that a description thereof is omitted herein. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

It should be appreciated that according to some examples of embodiments, a so-called “liquid” or flexible network concept may be implemented where the operations and functionalities of a network element, a network function, or of another entity of the network, may be performed in different entities or functions, such as in a node, host or server, in a flexible manner. Thus, a “division of labor” between involved network elements, functions or entities may vary case by case.

The subject disclosure, in some examples of embodies, relates to mitigation against access token theft attack in direct and indirect communications in SBA.

TS 33.501 Clause 13 discloses SBA authorization using OAuth 2.0.

IETF RFC 8705 addresses the binding of the OAuth 2.0 access token with the TLS certificate issue. For the purpose of sender-constrained access tokens, the client is identified towards the resource server by the fingerprint of its public key. During processing of an access token request, the authorization server obtains the client's public key from the TLS stack and associates its fingerprint with the respective access tokens. The resource server in the same way obtains the public key from the TLS stack and compares its fingerprint with the fingerprint associated with the access token.

Though the above RFC only addresses direct communication since it is relying on mTLS, and not addressing all the indirect communication cases (i.e., Model C and D) in 3GPP.

In current 3GPP specifications, specifically in the profiled OAuth 2.0 framework for SBA an access token is used for authorization, and an EE TLS certificate is used for authentication. Thus, if an access token granted to a first network function NF1 to consume services of a second network function acting as a producer NF2, is leaked to a third network function NF3 with a valid certificate, that NF3 could consume the services of NF2, even if it is not authorized to do so. The approach of 3GPP to this problem at the moment is to rely on ‘good’ implementations that don't allow the leakage of access tokens and prevent what can be denominated ‘token reply’ problem.

RFC 8705 as currently specified does not solve the problem in 5G SBA for several reasons:
Indirect communication introduced in Rel 16. The communication between (consumer) NFc and (producer) NFp is done via SCP (service communication proxy). So, TLS (transport layer security) mutual authentication is performed between NFs and SCP.
3GPP specified CCA (Client Credentials Assertion) to enable the client authentication in indirect communication-based deployments. RFC8705 does not cover this feature.
5G SBA uses HTTP/2, and according to RFC 9113 ‘TLS 1.3 post-handshake authentication’ is to be avoided.

Currently, in the case of authorization using OAuth 2.0 there exists no provision to prevent access token theft/abuse type of attacks in the case of indirect communication like in 5G SBA. It shall be noted that CCA as such is only standardized and used for authentication, so it does not solve the token theft problem. In other words, in the case of indirect communication, NRF and NFp currently have no means to verify which NF was the originator of the access token/service request, and whether a malicious or compromised SCP or NF is performing a token theft attack.

Therefore, the problem is still unsolved, and the proposed solution according to various examples of embodiments of the subject disclosure addresses the same. Hence, the various examples of embodiments of the subject disclosure are advantageous in that they enable to solve at least part of this problem.

By solving such problem(s), at least one or more examples of embodiments may advantageously deploy at least one of the below features
use a binding between an access token used for authorization and a certificate used for authentication;
perform mutual authentication between network functions NFs, even in deployments based on indirect communication;
allow for CCA to be used for authorization, in addition to its use for authentication.

The current problem is addressed in a single PLMN non roaming scenario, wherein the public key of the NF Service Consumer can be obtained via the CCA used in indirect communication.

NRF validates the CCA using the NF provided public key, and also verifies whether the public key in the CCA is present in the previously registered NF profile (it shall be noted that it may be assumed according to various examples of embodiments that going forward all the NFs, be it consumer or producer have to be registered into NRF or any other repository). This information (public key) is either available during NF registration (currently NF registration is only via direct communication, i.e., in principle mutual TLS is used), or the information can be obtained from the OAM by using the NF Instance ID present in the CCA.

Once verified, NRF adds the public key (or hash of public key or certificate fingerprint) of the NFc in the generated access token and binds the access token in such way that only the NFc which provides the proof of procession of the corresponding private key can use that access token.

During service request, NFc when sending the request to NFp (along with the CCA), NFp verifies whether the public key present in the access token matches the one present in the CCA. In the case of successful verification, i.e., the verification of the public key present in the access token against the CCA, NFp provides the service.

Furthermore, in the case there may be need to protect the complete path (and authenticate/authorize) all the SCPs in that path for the access token request by the NFc to NRF, and the service request from NFc to NFp, it is proposed according to various examples of embodiments that the enhancement of the access token to include the intermediary SCPs as well.

According to at least some examples of embodiments of the present disclosure, different Variants may be envisioned to solve the above-mentioned problem.

Variant I: RFC8705 Based Solution. To Adopt the RFC there is Need to Make for Example at Least the Following Changes in the Signaling:
NFc public key is bound with the access token; and/or.
NFp validate the access token (NFc pub key) against the CCA, and then it provides the service; and/or
By validating the access token, it is ensured that it has not been stolen or abused, thus it is meant for the real NF consumer which sent the request.

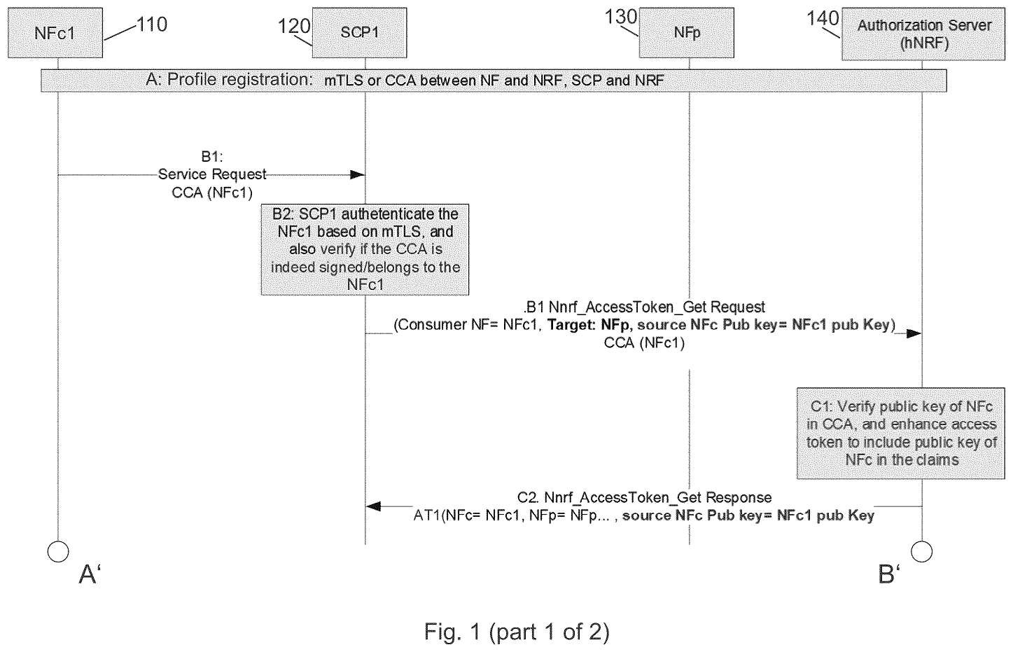

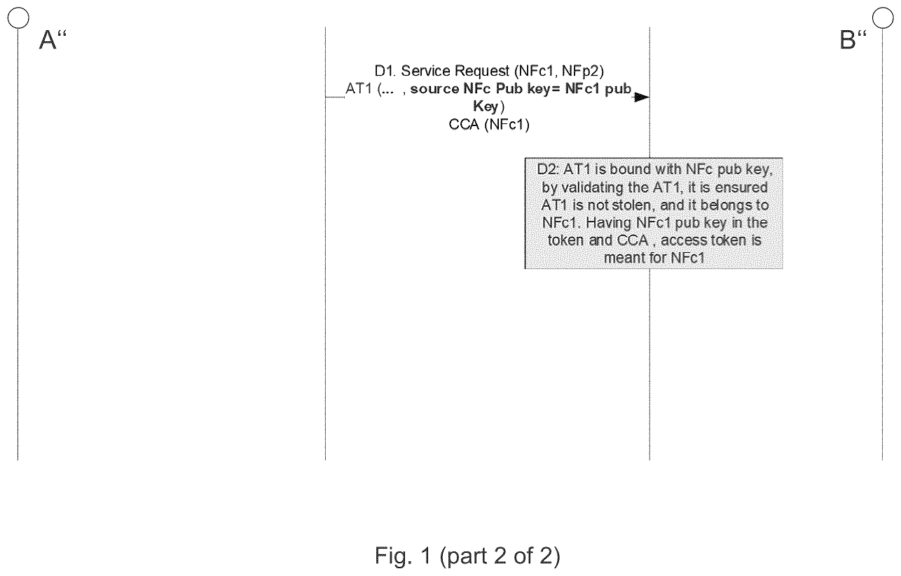

Referring now to FIG. 1 (consisting of parts 1 of 2 and 2 of 2; to be connected at A′-A″ and B′-B″), there is shown the working for Model D, wherein similarly it is adaptable to Model C as well.

Network entities are denoted with numerals 110, 120, 130, and 140 here. Signaling, i.e. messages, exchanged between them is/are denoted by arrows, and a processing at an entity is represented by a “box” illustrated below the respective entity. Network functions NF are illustrated as consumer NFc1, and producer NFp, a service control point is denoted as SCP, and an authorization server as hNRF (e.g. a home Network Repository Function).

### A. NFs (Consumer and Producer) Profiles Registration (not Shown in FIG. 1)

NFc 110 during the profile registration at the NRF 140 (or at the OAM) also registers its public key (or a hash or fingerprint of the public key). Since the profile registration should occur via mTLS (not mandatory), NRF 140 may have the public key from the corresponding TLS certificate. In case a different key is used for access token signing than the one present in the mTLS, this can also be updated at the NRF 140 as a part of NF profile registration.

In case this information is not available at the NRF 140, it can request from the OAM the corresponding information using the NFc Instance ID information.

It shall be noted that it may be assumed according to various examples of embodiments that in future all the NFs (both the consumer and the producers) register at the NRF.

### B. Access Token Request to the NRF by the NFc/SCP

As shown denoted with B1, the NFc 110, when sending the service request also sends its CCA along with it. In case of both, Model C and Model D, the service request contains the CCA.

Even though the CCA is short lived (it's validity may expire after a certain time period), but still in the case where it might be assumed that even CCA is stolen, the following procedure is valid:

As denoted with B2, SCP 120 when receiving the access token request from the NFc 110 (in Model C), or when receiving the service request and then correspondingly generating the access token request (in Model D), firstly it verifies whether the CCA is indeed signed and belongs to the NFc 110 sending the message.

Since SCP 120 has direct mTLS with the NFc 110, it can verify if the public key present in the TLS connection is the same as the one present in the CCA. In case different keys are used for TLS and CCA signing, SCP 120 verifies if the NF Instance ID present in the TLS certificate information is the same as the one present in CCA. Only after successful verification, SCP 120 either forwards (denoted by .B1) the access token request to NRF 140 (Model C), or generates the access token request (Model D) and sends it to NRF 140, including the information of the public key of the NFc 110 in the access token request.

### C. Access Token Generation and Proof of Procession Verification by NRF 140

As denoted with C1, the NRF 140 when it received the access token request along with the CCA of the NFc 110, after performing e.g. the stated verification in the Clause 13.3.8 in TS 33.501, it verifys that the public key present in CCA is indeed the public key which belongs to the NFc 110 whose instance ID is present in the access token request (using the NF profile registration information), and appends the public key present in the CCA in the access token. Alternatively, NRF 140 may also add a signed HASH of public key or NFc certificate fingerprint in the access token.

It shall be noted that in the case the NF Service consumer (NFc 110) does not register at the NRF 140, even then the CCA generated by the NFc 110 will serve as a proof of possession of private key, and the corresponding public key will be added in the access token.

### D. Service Request Sending to the NF Service Producer (NFp 130)

As shown in FIG. 1, part 2, the NF Service Producer (NFp 130) when receiving this request (denoted with D1, along with the CCA of NFc1 (consumer NFC being denoted with 110), can verify whether the public key present in the access token (denoted in FIG. 1, part 2, in D2 as—in short—AT) is the same as the one in the CCA. In case of successful verification, service is provided.

### Variant II: Binding the Access Token to the Complete Path/Intermediary SCP by Appending/Modifying the Access Token Request Sent to the NRF

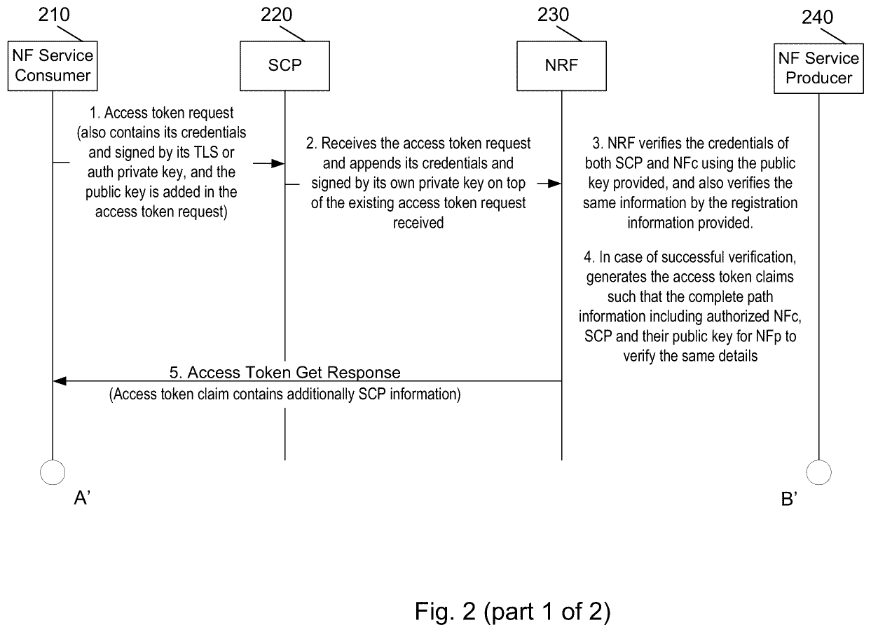

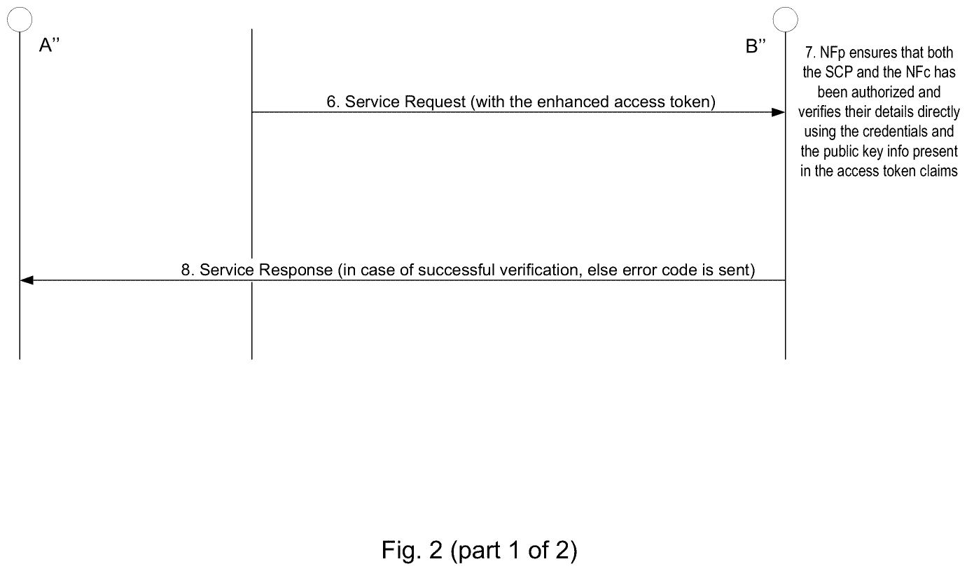

Referring now to FIG. 2 (consisting of parts 1 of 2 and 2 of 2; to be connected at A′-A″ and B′-B″), there are shown signaling flows in relation to mitigation against access token theft attack in direct and indirect communications in SBA according to various examples of embodiments of the subject disclosure.

Network entities are denoted with numerals 210, 220, 230, and 240 here, Signaling, i.e. messages exchanged between them are denoted by (numbered) arrows. Network functions NF are illustrated as consumer NF (210), and a producer NF (240), a service control point as SCP denoted by 220, and an authorization server as NRF (e.g. a Network Repository Function) is denoted by 230.

Not shown in FIG. 2 is a “Step 0”. Here it is assumed that the NF registration (and the SCP registration) at the NRF occurs via direct communication or via OAM, such that the NRF already has the TLS certificate or the public key pair of the OAuth signing key of the corresponding NF and the SCP

As shown in a Step 1: NF Service Consumer 210, when sending an access token request to the NRF 230 (optionally either directly or (as shown in FIG. 2) via SCP 220), it also includes its credentials such as NF Instance ID, NF Type, Slice ID, PLMN ID, etc. The corresponding credentials are already considered part of the TLS certificate of the client (e.g. part of the specs, TS 33.310). Once these credentials are added in the access token request, the corresponding information element(s) is (are) signed by the NF Service Consumer 210 either using its TLS certificate, or via its OAuth signing private key. Once signed, the public key or information on how to access the public key to verify the information is also added in the access token request. This info can be either added as a complete key, or in the form of a URI to fetch the key.

As shown in a Step 2: In the case of indirect communication, i.e. if the SCP 220 is in between and receives the access token request, the SCP 220 also adds its own credential information (such as SCP ID, PLMN Info, etc) on top of the existing access token request as a separate information element (IE), and signs it using its own TLS certificate or OAuth private key. Subsequently, the SCP 220 also adds the information on how to access the key used (or optionally the key as such), to verify the signed credentials.

It shall be noted that in the case of Model D, wherein SCP 220 itself generates the access token request, the NF Service Consumer 210 can send its details and sign it and provide it to the SCP 220, which can then append this information in the access token request that the SCP 220 generates

It shall be noted that in the case of multiple SCPs in the hop (not illustrated in FIG. 2), every SCP adds its details on top of the access token request received from the previous entity, signs it and then forwards it to the next entity in the communication chain

As shown in a Step 3: The NRF 230, when having received the final access token request (from/via NFc and/or one or more SCPs), besides performing the general verification as (e.g.) defined in TS 33.501 Clause 13, the NRF also verifies the credentials of both, the one (or more) SCP 220 and NFc 210 using the respective public key(s) provided by NFc 210 and SCP (or several SCPs) 220, and verifies the same information (i.e. the credentials, certificate(s), key(s)) also against the registration information provided in Step 0.

As shown in a Step 4: In case of successful verification, the NRF 230 generates the access token such that the complete path information, including authorized NFc 210, (one or more) SCP 220 and their (respective) public key for NFp 240 to verify the same details, and the complete path information is added in the access token.

As shown in a Step 5: The NRF 230 sends the enhanced access token with additional information back to SCP 220 (or NFc 210) based upon and/or dependent on the communication model used. FIG. 2, part 1 shows signaling in S5 being sent back from NRF 230 via SCP 220 to NFc 210.

As shown in a Step 6: The NFc 210 (or SCP 220 as in FIG. 2, part 2) sends the service request with the enhanced access token to the NF Service producer, NFp 240.

As shown in a step 7: The NFp 240 ensures that both the SCP 220 and the NFc 210 have been verified and authorized by the NRF 230, and verifies their details directly using the credentials and the public key info present in the access token.

As shown in a step 8: The NFp 240 sends a service response to the NFc 210 in the case of successful verification, else an error code is sent instead.

In the following, further examples of embodiments are described in relation to the aforementioned methods and/or apparatuses.

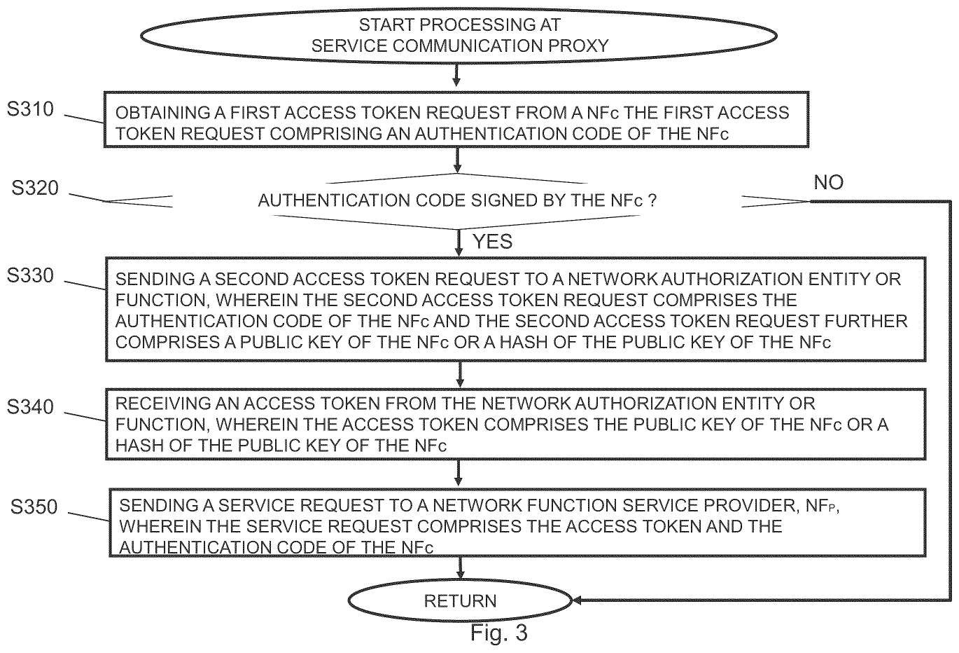

Referring now to FIG. 3, there is shown a flowchart illustrating steps corresponding to an example method according to various examples of embodiments of the subject disclosure.

In particular, according to FIG. 3, in S310, the method comprises obtaining a first access token request from a network function service consumer, NFc, the first access token request comprising an authentication code of the NFc

Further, in S320, the method comprises authenticating whether the authentication code is signed by the NFc.

Additionally, if the authentication code is signed by the NFc (YES in S320), in S330, the method comprises sending a second access token request to a network authorization entity or function, wherein the second access token request comprises the authentication code of the NFc and the second access token request further comprises a public key of the NFc or a hash of the public key of the NFc.

Further, in S340, the method comprises receiving an access token from the network authorization entity or function, wherein the access token comprises the public key of the NFc or a hash of the public key of the NFc.

Moreover, in S350, the method comprises sending a service request to a network function service provider, NFp, wherein the service request comprises the access token and the authentication code of the NFc.

Moreover, according to at least some examples of embodiments, the method may further comprise receiving a service request comprising the authentication code from the NFc and obtaining the first access token request by generating the first access token request based on the received service request; or obtaining the first access token request by receiving the first access token request from the NFc.

Furthermore, according to various examples of embodiments, the method may comprise that the verifying comprises comparing a public key included in the authentication code with a public key present in a TLS connection between a service communication proxy, SCP, and the NFc; and/or comparing a NF Instance ID included in the authentication code with a NF Instance ID present in a TLS certificate information associated with the TLS connection; and/or wherein the authentication code is signed based on the TLS certificate or via an OAuth signing private key of the NFc.

Moreover, according to at least some examples of embodiments, the method may comprise that the sending of the second access token request comprises adding a signed authentication code of the SCP to the second access token request; and/or sending the second access token request to the network authorization entity or function via at least one further SCP.

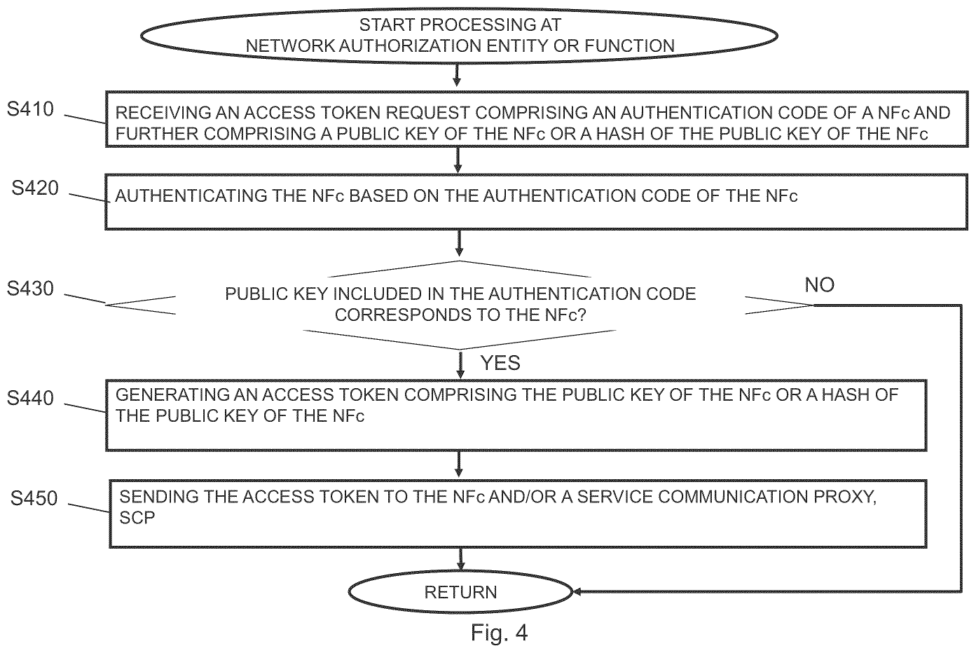

Referring now to FIG. 4, FIG. 4 shows a flowchart illustrating steps corresponding to an example method according to various examples of embodiments of the subject disclosure.

In particular, according to FIG. 4, in S410, the method comprises receiving an access token request comprising an authentication code of a network function service consumer, NFc, and further comprising a public key of the NFc or a hash of the public key of the NFc.

Further, in S420, the method comprises authenticating the NFc based on the authentication code of the NFc.

Additionally, in S430, the method comprises verifying, whether a public key included in the authentication code corresponds to the NFc.

Furthermore, if verified that the public keys are the same (YES in S430), in S440, the method comprises generating an access token comprising the public key of the NFc or a hash of the public key of the NFc.

Moreover, in S450, the method comprises sending the access token to the NFc and/or a service communication proxy, SCP.

Moreover, according to at least some examples of embodiments, the verifying may comprise comparing the public key included in the authentication code with a public key registered at a network authorization entity or function in relation to the NFc.

Moreover, according to at least some examples of embodiments, the received access request may further comprise an authentication code from a service communication proxy, SCP; and the verifying may further comprise verifying the authentication code from the SCP.

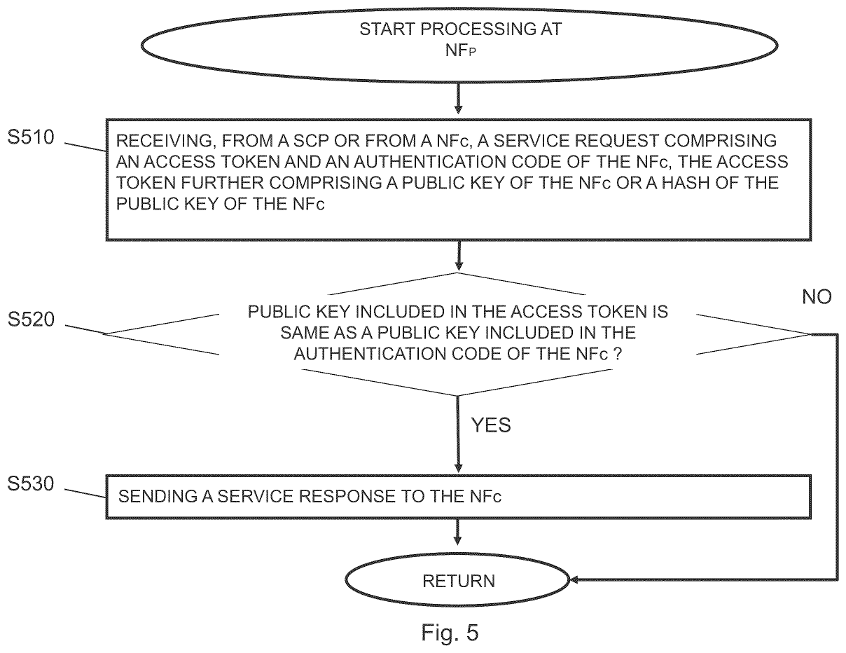

Referring now to FIG. 5, FIG. 5 shows a flowchart illustrating steps corresponding to an example method according to various examples of embodiments of the subject disclosure.

In particular, according to FIG. 5, in S510, the method comprises receiving, from a service communication proxy, SCP, or from a network function service consumer, NFc, a service request comprising an access token and an authentication code of the NFc, the access token further comprising a public key of the NFc or a hash of the public key of the NFc.

Further, in S520, the method comprises verifying, whether the public key included in the access token is same as a public key included in the authentication code of the NFc.

Additionally, if verified that the public keys are the same (YES in S520), in S530, the method comprises sending a service response to the NFc.

Furthermore, according to various examples of embodiments with reference to FIGS. 3 t 5, the authentication code may be a client credentials assertion, CCA.

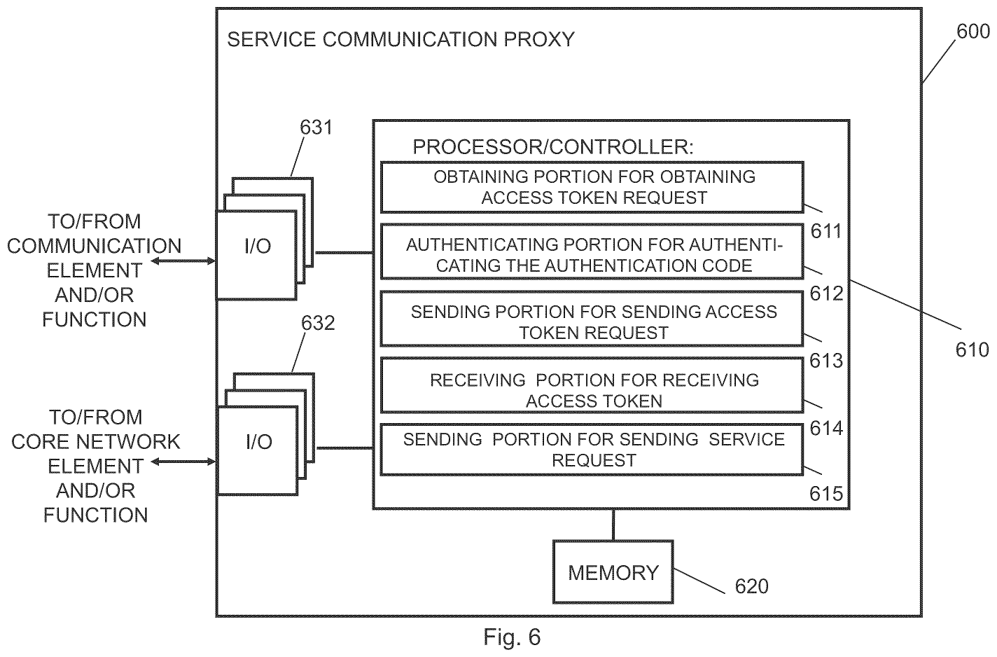

Referring now to FIG. 6, FIG. 6 shows a block diagram illustrating an example apparatus according to various examples of embodiments of the subject disclosure.

Specifically, FIG. 6 shows a block diagram illustrating an apparatus 600, which may represent a service communication proxy (e.g. SCP 120, 220) as outlined above with reference to FIGS. 1 and 2, according to various examples of embodiments, which may participate in mitigation against access token theft attack in direct and indirect communications in SBA. Furthermore, even though reference is made to a service communication proxy, the service communication proxy may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The apparatus 600 shown in FIG. 6 may include a processing circuitry, a processing function, a control unit or a processor 610, such as a CPU or the like, which is suitable to enable mitigation against access token theft attack in direct and indirect communications in SBA. The processor 610 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 631 and 632 denote input/output (I/O) units or functions (interfaces) connected to the processor or processing function 610. The I/O units 631 and 632 may be a combined unit including communication equipment towards several entities/elements, or may include a distributed structure with a plurality of different interfaces for different entities/elements. Reference sign 620 denotes a memory usable, for example, for storing data and programs/instructions to be executed by the processor or processing function 610 and/or as a working storage of the processor or processing function 610. It is to be noted that the memory 620 may be implemented by using one or more memory portions of the same or different type of memory, but may also represent an external memory, e.g. an external database provided on a cloud server.

The processor or processing function 610 is configured to execute processing related to the above described processing. In particular, the processor or processing circuitry or function 610 includes one or more of the following sub-portions. Sub-portion 611 is an obtaining portion, which is usable as a portion for obtaining a first access token request from a network function service consumer. The portion 611 may be configured to perform processing according to S310 of FIG. 3. Further, sub-portion 612 is an authenticating portion, which is usable as a portion for authenticating whether the authentication code is signed by the NFc. The portion 612 may be configured to perform processing according to S320 of FIG. 3. Moreover, sub-portion 613 is a sending portion, which is usable as a portion for sending a second access token request. The portion 613 may be configured to perform processing according to S330 of FIG. 3. Further, sub-portion 614 is a receiving portion, which is usable as a portion for receiving an access token. The portion 614 may be configured to perform processing according to S340 of FIG. 3. Moreover, sub-portion 615 is a sending portion, which is usable as a portion for sending a service request. The portion 615 may be configured to perform processing according to S350 of FIG. 3.

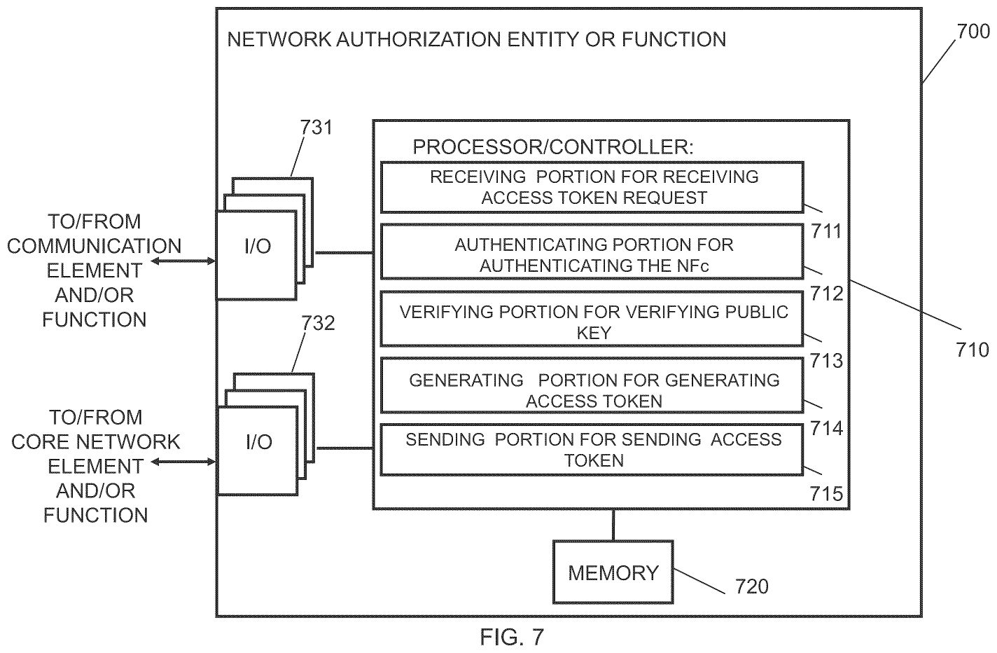

Referring now to FIG. 7, FIG. 7 shows a block diagram illustrating an example apparatus according to various examples of embodiments of the subject disclosure.

Specifically, FIG. 7 shows a block diagram illustrating an apparatus 700, which may represent a network authorization entity or function (e.g. NRF 140, 230) as outlined above with reference to FIGS. 1 and 2, according to various examples of embodiments, which may participate in mitigation against access token theft attack in direct and indirect communications in SBA. Furthermore, even though reference is made to a network authorization entity or function, the network authorization entity or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The apparatus 700 shown in FIG. 7 may include a processing circuitry, a processing function, a control unit or a processor 710, such as a CPU or the like, which is suitable to enable mitigation against access token theft attack in direct and indirect communications in SBA. The processor 710 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 731 and 732 denote input/output (I/O) units or functions (interfaces) connected to the processor or processing function 710. The I/O units 731 and 732 may be a combined unit including communication equipment towards several entities/elements, or may include a distributed structure with a plurality of different interfaces for different entities/elements. Reference sign 720 denotes a memory usable, for example, for storing data and programs/instructions to be executed by the processor or processing function 710 and/or as a working storage of the processor or processing function 710. It is to be noted that the memory 720 may be implemented by using one or more memory portions of the same or different type of memory, but may also represent an external memory, e.g. an external database provided on a cloud server.

The processor or processing function 710 is configured to execute processing related to the above described processing. In particular, the processor or processing circuitry or function 710 includes one or more of the following sub-portions. Sub-portion 711 is a receiving portion, which is usable as a portion for receiving an access token request. The portion 711 may be configured to perform processing according to S410 of FIG. 4. Further, sub-portion 712 is a authenticating portion, which is usable as a portion for authenticating the NFc. The portion 712 may be configured to perform processing according to S420 of FIG. 4. Moreover, sub-portion 713 is a verifying portion, which is usable as a portion for verifying a public key. The portion 713 may be configured to perform processing according to S430 of FIG. 4. Further, sub-portion 714 is a generating portion, which is usable as a portion for generating an access token. The portion 714 may be configured to perform processing according to S440 of FIG. 4. Moreover, sub-portion 715 is a sending portion, which is usable as a portion for sending an access token. The portion 715 may be configured to perform processing according to S450 of FIG. 4.

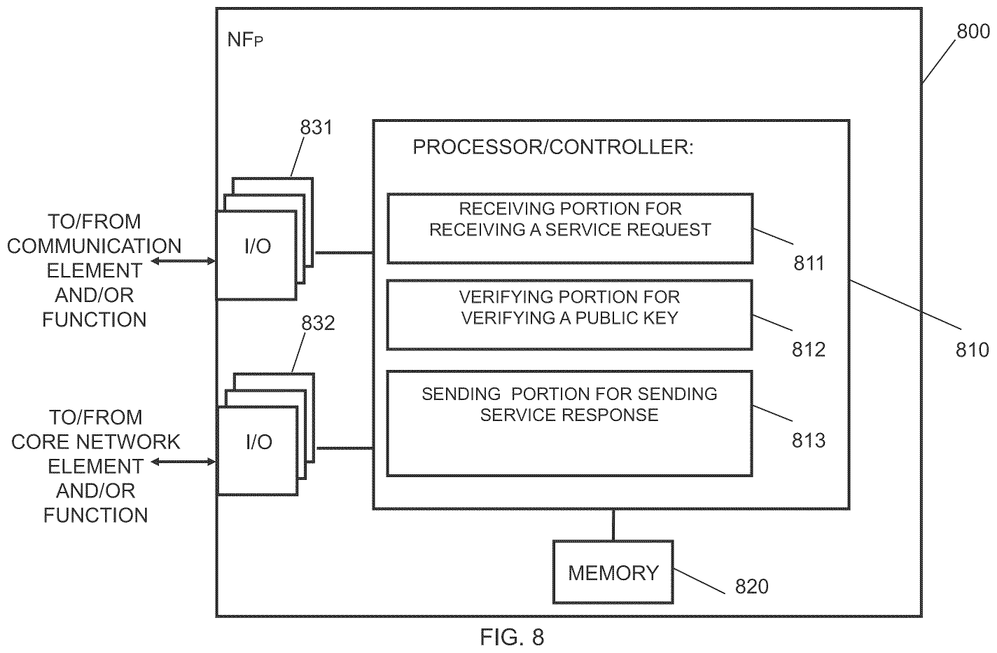

Referring now to FIG. 8, FIG. 8 shows a block diagram illustrating an example apparatus according to various examples of embodiments of the subject disclosure.

Specifically, FIG. 8 shows a block diagram illustrating an apparatus 800, which may represent a NFp (e.g. NFp 130, 240) as outlined above with reference to FIGS. 1 and 2, according to various examples of embodiments, which may participate in mitigation against access token theft attack in direct and indirect communications in SBA. Furthermore, even though reference is made to a NFp, the NFp may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The apparatus 800 shown in FIG. 8 may include a processing circuitry, a processing function, a control unit or a processor 810, such as a CPU or the like, which is suitable to enable mitigation against access token theft attack in direct and indirect communications in SBA. The processor 810 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 831 and 832 denote input/output (I/O) units or functions (interfaces) connected to the processor or processing function 810. The I/O units 831 and 832 may be a combined unit including communication equipment towards several entities/elements, or may include a distributed structure with a plurality of different interfaces for different entities/elements. Reference sign 820 denotes a memory usable, for example, for storing data and programs/instructions to be executed by the processor or processing function 810 and/or as a working storage of the processor or processing function 810. It is to be noted that the memory 820 may be implemented by using one or more memory portions of the same or different type of memory, but may also represent an external memory, e.g. an external database provided on a cloud server.

The processor or processing function 810 is configured to execute processing related to the above described processing. In particular, the processor or processing circuitry or function 810 includes one or more of the following sub-portions. Sub-portion 811 is a receiving portion, which is usable as a portion for receiving a service request. The portion 811 may be configured to perform processing according to S510 of FIG. 5. Further, sub-portion 812 is a verifying portion, which is usable as a portion for verifying a public key. The portion 812 may be configured to perform processing according to S520 of FIG. 5. Moreover, sub-portion 813 is a sending portion, which is usable as a portion for sending a service response. The portion 813 may be configured to perform processing according to S530 of FIG. 5.

It shall be noted that the apparatuses 600, 700 and 800 as outlined above with reference to FIGS. 6, 7 and 8 may comprise further/additional sub-portions, which may allow the apparatuses 600, 700 and 800 to perform such methods/method steps as outlined above with reference to FIGS. 3, 4 and 5.

Further, according to various examples of embodiments, an apparatus may comprise means for obtaining a first access token request from a network function service consumer, NFc, the first access token request comprising an authentication code of the NFc; means for authenticating whether the authentication code is signed by the NFc; means for sending a second access token request to a network authorization entity or function, wherein the second access token request comprises the authentication code of the NFc and further comprises a public key of the NFc or a hash of the public key of the NFc; based thereon, means for receiving an access token from the network authorization entity or function, wherein the access token comprises the public key of the NFc or a hash of the public key of the NFc; and means for sending a service request to a network function service provider, NFp, wherein the service request comprises the access token and the authentication code of the NFc.

According to various examples of embodiments, the apparatus may further comprise means for receiving a service request comprising the authentication code from the NFc and for obtaining the first access token request by generating the first access token request based on the received service request; or means for obtaining the first access token request by receiving the first access token request from the NFc.

According to various examples of embodiments, the apparatus may further comprise means for comparing a public key included in the authentication code with a public key present in a TLS connection between the apparatus and the NFc; and/or means for comparing a NF Instance ID included in the authentication code with a NF Instance ID present in a TLS certificate information associated with the TLS connection; and/or wherein the authentication code is signed based on the TLS certificate or via an OAuth signing private key of the NFc.

According to various examples of embodiments, the apparatus may further comprise means for adding a signed authentication code of the apparatus to the second access token request; and/or means for sending the second access token request to the network authorization entity or function via at least one service communication proxy, SCP.

According to at least some examples of embodiments, an apparatus may comprise means for receiving an access token request comprising an authentication code of a network function service consumer, NFc, and further comprising a public key of the NFc or a hash of the public key of the NFc; means for authenticating the NFc based on the authentication code of the NFc; means for verifying, whether a public key included in the authentication code corresponds to the NFc; if verified that the public keys are the same, means for generating an access token comprising the public key of the NFc or a hash of the public key of the NFc; and means for sending the access token to the NFc and/or a service communication proxy, SCP.

According to at least some examples of embodiments, the apparatus may further comprise means for comparing the public key included in the authentication code with a public key registered at a network authorization entity or function in relation to the NFc.

According to at least some examples of embodiments, the received access request may further comprise an authentication code from a service communication proxy, SCP; and the apparatus may further comprise means for verifying the authentication code from the SCP.

According to at least some examples of embodiments, an apparatus may comprise means for receiving, from a service communication proxy, SCP, or from a network function service consumer, NFc, a service request comprising an access token, the access token comprising an authentication code of the NFc and further comprising a public key of the NFc or a hash of the public key of the NFc; means for verifying, whether the public key included in the access token is same as a public key included in the authentication code of the NFc; and if verified that the public keys are the same, means for sending a service response to the NFc.

Furthermore, according to various examples of embodiments, there may be provided a computer program product for a computer, including software code portions for performing the steps of any of the above-outlined methods, when said product is run on the computer.

According to at least some examples of embodiments, the computer program product may include a computer-readable medium on which said software code portions are stored, and/or the computer program product may be directly loadable into the internal memory of the computer and/or transmittable via a network by means of at least one of upload, download and push procedures.

It should be appreciated that
an access technology via which traffic is transferred to and/or from an entity in the communication network may be any suitable present or future technology, such as WLAN (Wireless Local Access Network), WiMAX (Worldwide Interoperability for Microwave Access), LTE, LTE-A, 5G, 6G, Bluetooth, Infrared, and the like may be used; additionally, examples of embodiments may also apply wired technologies, e.g. IP based access technologies like cable networks or fixed lines.
examples of embodiments suitable to be implemented as software code or portions thereof and being run using a processor or processing function are software code independent and can be specified using any known or future developed programming language, such as a high-level programming language, such as objective-C, C, C++, C #, Java, Python, Javascript, other scripting languages etc., or a low-level programming language, such as a machine language, or an assembler.
implementation of examples of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
examples of embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module including such chip or chipset;
examples of embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
examples of embodiments may also be implemented as computer program products, including a computer usable medium having a computer readable program code embodied therein, the computer readable program code adapted to execute a process as described in embodiments, wherein the computer usable medium may be a non-transitory medium.

The term “circuitry” may refer to one or more or all of the following examples of embodiments:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (e.g., tangible, not a signal) as opposed to a limitation on data storage persistency (e.g., RAM vs. ROM).

As used herein, “at least one of the following:” and “at least one of” and similar wording, where the list of two or more elements are joined by “and” or “or”, mean at least any one of the elements, or at least any two or more of the elements, or at least all the elements.

Although the subject disclosure has been described herein before with reference to various examples of embodiments thereof, the subject disclosure is not limited thereto and it will be apparent to a person skilled in the art that various modifications can be made to the subject disclosure.

The following meanings for the abbreviations used herein apply:
3GPP 3^{rd} Generation Partnership Project
3GGP2 3^{rd} Generation Partnership Project 2
4G Fourth Generation
5G Fifth Generation
5GC 5G Core Network
6G Sixth Generation
AP Access Point
AT Access Token
API Application Programming Interface
BS Base Station
CCA Client Credentials Assertion
CDMA Code Division Multiple Access
EE End-to-end (encryption)
eNB Evolved Node B
ETSI European Telecommunications Standards Institute
gNB Next Generation Node B
IEEE Institute of Electrical and Electronics Engineers
ITU International Telecommunication Union
LTE Long Term Evolution
LTE-A Long Term Evolution-Advanced
MAC Medium Access Control
MANETs Mobile Ad-Hoc Networks
NB Node B
NF Network Function
NG-RAN Next Generation Radio Access Network
NR New Radio
NRF Network Repository Function
NW Network
OAM Operations, Administration, and Maintenance
PLMN Public Land Mobile Network
RAM Random Access Memory
RAN Radio Access Network
Rel Release
ROM Read Only Memory
RRC Radio Resource Control
SBA Service-Based Architecture
SCP Service Communication Proxy
TISPAN Telecoms & Internet converged Services & Protocols for Advanced Networks
TLS Transport Layer Security
UE User Equipment
URI Uniform Resource Identifier
UWB Ultra-Wideband
WCDMA Wideband Code Division Multiple Access
WiMAX Worldwide Interoperability for Microwave Access
WLAN Wireless Local Area Network

1. A method, comprising:
obtaining a first access token request from a network function service consumer, NFc, the first access token request comprising an authentication code of the NFc;
authenticating the network function service consumer, NFc, by checking whether the authentication code is signed by the NFc;
sending a second access token request to a network authorization entity or function, wherein the second access token request comprises the authentication code of the NFc and the second access token request further comprises a public key of the NFc or a hash of the public key of the NFc;
based thereon, receiving an access token from the network authorization entity or function, wherein the access token comprises the public key of the NFc or a hash of the public key of the NFc; and
sending a service request to a network function service provider, NFp, wherein the service request comprises said access token and the authentication code of the NFc.

2. The method according to claim 1, further comprising
receiving a service request comprising the authentication code from the NFc and obtaining the first access token request by generating the first access token request based on the received service request; or
obtaining the first access token request by receiving the first access token request from the NFc.

3. The method according to claim 1, wherein the authenticating comprises
comparing a public key included in the authentication code with a public key present in a TLS connection between a service communication proxy, SCP, and the NFc; and/or
comparing a NF Instance ID included in the authentication code with a NF Instance ID present in a TLS certificate information associated with the TLS connection; and/or
wherein the authentication code is signed based on the TLS certificate or via an OAuth signing private key of the NFc.

4. The method according to claim 1, wherein the sending of the second access token request comprises
adding a signed authentication code of the SCP to the second access token request; and/or
sending the second access token request to the network authorization entity or function via at least one further SCP.

5. A method, comprising:
receiving an access token request comprising an authentication code of a network function service consumer, NFc, and further comprising a public key of the NFc or a hash of the public key of the NFc;
authenticating the NFc based on the authentication code of the NFc;
verifying, whether a public key included in the authentication code corresponds to the NFc;
if verified that the public keys are the same,
generating an access token comprising the public key of the NFc or a hash of the public key of the NFc; and
sending the access token to the NFc and/or a service communication proxy, SCP.

6. The method according to claim 5, wherein the verifying comprises
comparing the public key included in the authentication code with a public key registered at a network authorization entity or function in relation to the NFc.

7. The method according to claim 5, wherein
the received access request further comprises an authentication code from a service communication proxy, SCP; and
the verifying further comprises verifying the authentication code from the SCP.

8. The method according to claim 5, wherein
generating said access token comprises
using the public key of the NFc or a hash of the public key of the NFc stored in the NRF or received in the access token request.

9. A method, comprising:
receiving, from a service communication proxy, SCP, or from a network function service consumer, NFc, a service request comprising an access token and an authentication code of the NFc, the access token further comprising a public key of the NFc or a hash of the public key of the NFc;
verifying, whether the public key included in the access token is same as a public key included in the authentication code of the NFc; and
if verified that the public keys are the same, sending a service response to the NFc.

10. The method according to claim 9, wherein the authentication code is a client credentials assertion, CCA.

11. An apparatus, comprising
at least one processor; and
at least one memory storing instructions that, when executed by the at least one processor, cause the apparatus at least to:
obtain a first access token request from a network function service consumer, NFc, the first access token request comprising an authentication code of the NFc;
authenticate the network function consumer, NFc, based on a check whether the authentication code is signed by the NFc;
send a second access token request to a network authorization entity or function, wherein the second access token request comprises the authentication code of the NFc and the second access token request further comprises a public key of the NFc or a hash of the public key of the NFC;
based thereon, receive an access token from the network authorization entity or function, wherein the access token comprises the public key of the NFc or a hash of the public key of the NFc; and
send a service request to a network function service provider, NFp, wherein the service request comprises said access token and the authentication code of the NFc.

12. The apparatus according to claim 11, wherein the apparatus is further caused to
receive a service request comprising the authentication code from the NFc and obtain the first access token request by generating the first access token request based on the received service request; or
obtain the first access token request by receiving the first access token request from the NFc.

13. The apparatus according to claim 11, wherein the apparatus caused to authenticate further comprises the apparatus being caused to
compare a public key included in the authentication code with a public key present in a TLS connection between the apparatus and the NFc; and/or
compare a NF Instance ID included in the authentication code with a NF Instance ID present in a TLS certificate information associated with the TLS connection; and/or
wherein the authentication code is signed based on the TLS certificate or via an OAuth signing private key of the NFc.

14. The apparatus according to claim 11, wherein the apparatus caused to send the second access token request further comprises the apparatus being caused to
add a signed authentication code of the apparatus to the second access token request; and/or
sending the second access token request to the network authorization entity or function via at least one service communication proxy, SCP.

15. An apparatus, comprising
at least one processor; and
at least one memory storing instructions that, when executed by the at least one processor, cause the apparatus at least to:
receive an access token request comprising an authentication code of a network function service consumer, NFc, and further comprising a public key of the NFc or a hash of the public key of the NFc;
authenticate the NFc based on the authentication code of the NFc;
verify, whether a public key included in the authentication code corresponds to the NFc;
if verified that the public keys are the same, generate an access token comprising the public key of the NFc or a hash of the public key of the NFc; and
send the access token to the NFc and/or a service communication proxy, SCP.

16. The apparatus according to claim 15, wherein the apparatus caused to verify comprising the apparatus being caused to
compare the public key included in the authentication code with a public key registered at a network authorization entity or function in relation to the NFc.

17. The apparatus according to claim 15, wherein
the received access request further comprises an authentication code from a service communication proxy, SCP; and
the apparatus caused to verify further comprises the apparatus being caused to verify the authentication code from the SCP.

18. The apparatus according to claim 15, wherein the apparatus caused to generate said access token
uses the public key of the NFc or a hash of the public key of the NFc stored in the NRF or received in the access token request.

19. An apparatus, comprising
at least one processor; and
at least one memory storing instructions that, when executed by the at least one processor, cause the apparatus at least to:
receive, from a service communication proxy, SCP, or from a network function service consumer, NFc, a service request comprising an access token and an authentication code of the NFc, the access token further comprising a public key of the NFc or a hash of the public key of the NFc;
verify, whether the public key included in the access token is same as a public key included in the authentication code of the NFc; and
if verified that the public keys are the same, send a service response to the NFc.

20. The apparatus according to claim 19, wherein the authentication code is a client credentials assertion, CCA.
